(19) United States
(12) Patent Application Publication
(10) Pub. No.: US 2008/0091966 A1
(43) Pub. Date: Apr. 17, 2008

(54) Structure and method for booting an image signal processor

(75) Inventor: Li-Chun Hsu, Hsin-Chu City (TW)

Correspondence Address: Tung & Associates;Suite 120, 838 W. Long Lake Road, Bloomfield Hills, MI, 48302, US

(73) Assignee: Alpha Imaging Technology, R.O.C.

(21) Appl. No.: 11/581,034

(22) Filed: Oct. 13, 2006

(51) Int. Cl. G06F 1/00

(52) U.S. Cl. 713/500

(57) ABSTRACT

The present invention discloses a structure and a method for booting an image signal processor. The method comprises the steps of: providing an image processing module including an image signal processor and an interface; receiving a booting program from an external source by the interface; and initializing the image processing module according to the booting program by the image signal processor.

### BACKGROUND OF THE INVENTION

1. Field of the Invention

The present invention relates to a structure and method for booting an image signal processor (ISP), in particular to a low cost structure and method for booting an ISP, which reduce hardware cost and size of an image processing module.

2. Description of the Related Art

Nowadays digital imaging device have been widely used in many applications, such as digital cameras, digital video recorders, mobile phones (including camera phones and smart phones), personal digital assistants (PDAs), monitoring apparatuses, etc.

A digital imaging device typically comprises an image processing module. As shown in FIG. 1, the digital imaging apparatus 100 comprises a focus lens 10, an image sensor 20 which captures an image through the focus lens 10, an ISP 31 which processes image signals generated by the image sensor 20, a main memory 32 (such as an SRAM) assisting the operation of the ISP 31, an interface 33 for communication with circuitry external to the image processing module, and a non-volatile memory 40 (such as a flash memory) for storing booting program and various parameters. The interface 33 includes a serial interface 34 and a parallel interface 35; the former is a register read/write interface for transmitting parameters, while the latter is for transmitting image data. According to modern circuit chip integration technology, the ISP 31, the main memory 32 and the interface 33 may be integrated into one IC chip (shown in the figure by the dot-dash line 30, referred to hereinafter as “ISP integrated chip”), but it is not yet mature to integrate the non-volatile memory 40 also in the chip.

As shown in FIG. 2, in a portable electronic device such as a mobile phone or a PDA, in order that the device may be smaller and lighter, often the focus lens 10, the image sensor 20, the ISP integrated chip 30 and the non-volatile memory 40 are formed into a stand-alone image processing module 100, separated from a main control side 200. The main control side 200 typically comprises a main processor 70, and a non-volatile memory 80 in cooperation with the main processor 70. The main processor 70 may be, e.g., a base-band processor of a mobile phone, or an application processor in other applications. There are many programs and parameters stored in the non-volatile memory 80, for use by the main processor 70. The image processing module 100 is usually located at one side of a portable electronic device, such as at one side of the housing of a mobile phone, and electrically connected with the circuits (such as the base-band processor, the multi-media module, etc.) at the main control side 200 through connecting wires.

In the aforementioned conventional electronic device, the booting method for the ISP is shown in FIG. 3. First, the main control side 200 transmits power, clock, reset and other signals to the image processing module 100 (step S31). Next, the ISP 31 obtains parameters and a booting program to be executed from the non-volatile memory 40, to initialize the circuit parts of the ISP integrated chip 30 (step S32-S33). Thereafter, the main control side 200 and the image processing module 100 carry out a handshaking process (step S34). When everything is ready, the main control side 200 sends out commands, and the image processing module 100 starts operation (step S35-S36).

The aforementioned conventional structure and method have the following drawbacks. First, due to difficulties in integrating the non-volatile memory 40 into the ISP integrated chip 30, it is hard to further reduce the size of the image processing module 100, whether by stack package, MCM package, or other packaging methods. In other words, the desire that portable electronic device becomes smaller and lighter is not completely met. Besides, a stand-alone non-volatile memory 40 increases the hardware cost and the complexity in assembly.

In view of the foregoing drawbacks, the present invention proposes a low cost structure and method for booting an ISP, which reduce hardware cost and size of an image processing module.

### SUMMARY OF THE INVENTION

A first objective of the present invention is to provide a structure for an ISP, wherein the required booting program and parameters are stored separately to reduce hardware cost and size of an image processing module.

A second objective of the present invention is to provide a method for booting an ISP, wherein the required booting program and parameters are read by the main control side and sent to the ISP.

A third objective of the present invention is to provide an image processing module adapted for the aforementioned structure and booting method.

To achieve the foregoing objectives, according to an aspect of the present invention, a structure for booting an ISP comprises: (1) an image processing module; and (2) a main control side, wherein the image processing module includes (1a) an ISP for processing image signals, and (1b) an interface for communication between the image processing module and the main control side; wherein the main control side includes (2a) a main processor and (2b) a memory storing a booting program for the ISP; and wherein the booting program is sent from the main control side to the image processing module for booting the ISP.

According to another aspect of the present invention, a method for booting an ISP comprises the steps of: providing an image processing module which includes an ISP and an interface; receiving a booting program from a circuit external to the image processing module; and initializing the image processing module by the ISP according to the booting program.

According to a further aspect of the present invention, an image processing module comprises: a focus lens; an image sensor which captures an image through the focus lens; an ISP which processes an image signal generated by the image sensor; a main memory assisting the operation of the ISP; and an interface for communication with a circuit external to the image processing module, characterized in that the main memory is a volatile memory which receives a booting program from the circuit external to the image processing module.

According to the present invention, in addition to the booting program, it is also possible to transmit/receive various parameters by/from a circuit external to the image processing module. The parameters includes one or more of: focus calibration data, auto white balance data, color temperature detection data, color reproduction related data such as raw color property data or color matrix data, lens compensation data such as lens shading compensation data or chroma non-uniformity compensation data, etc.

For better understanding the objectives, characteristics, and effects of the present invention, the present invention will be described below in detail by illustrative embodiments with reference to the attached drawings.

### BRIEF DESCRIPTION OF THE DRAWINGS

FIG. 1 is a circuit diagram schematically showing a conventional image processing module.

FIG. 2 is a circuit diagram schematically showing an arrangement of a main control side and an image processing module in a conventional portable electronic device.

FIG. 3 is a flow chart showing a conventional booting process for an ISP.

FIG. 4 is a circuit diagram schematically showing a structure for booting an ISP according to a preferred embodiment of the present invention.

FIG. 5 is a flow chart showing a booting process for an ISP according to a preferred embodiment of the present invention.

### DESCRIPTION OF THE PREFERRED EMBODIMENT

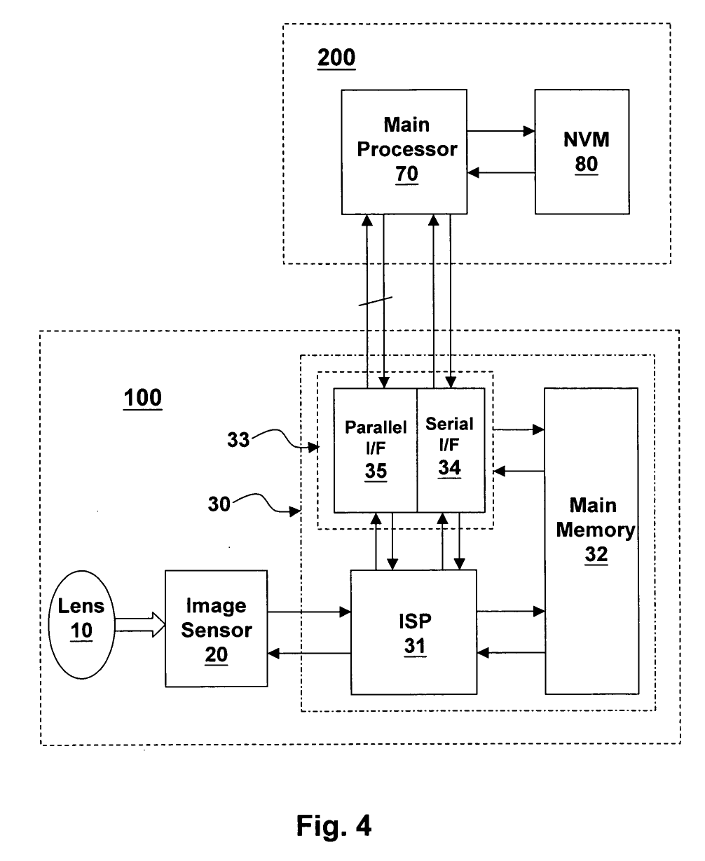

Referring to FIG. 4 which schematically shows a preferred embodiment according to the present invention, an image processing module 100 and a main control side 200 are electrically connected with each other. The image processing module 100 comprises a focus lens 10, an image sensor 20 which captures an image through the focus lens 10, an ISP 31 which processes an image signal generated by the image sensor 20, a main memory 32 assisting the operation of the ISP 31, and an interface 33 for communication with circuitry external to the image processing module; preferably, the ISP 31, the main memory 32 and the interface 33 are integrated into one IC chip 30. The interface 33 may include a serial interface 34 and a parallel interface 35; the former is a register read/write interface for transmitting parameters, while the latter is for transmitting image data.

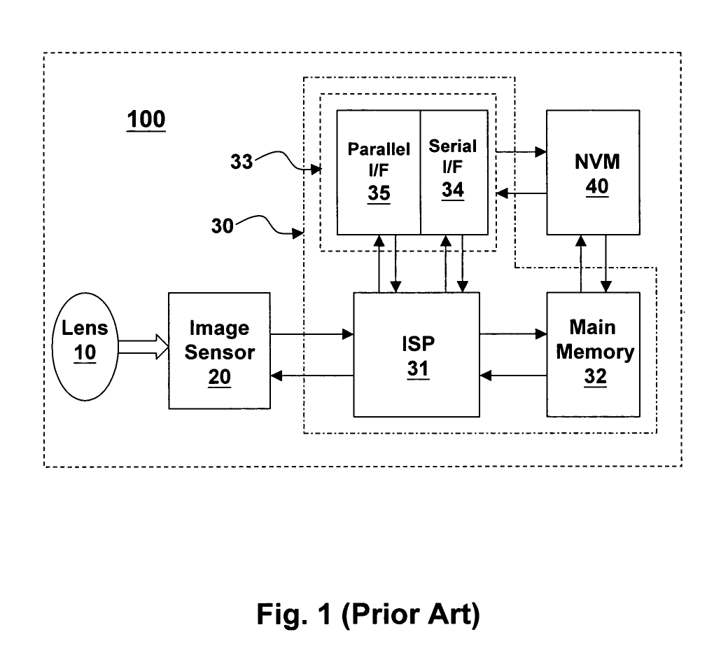

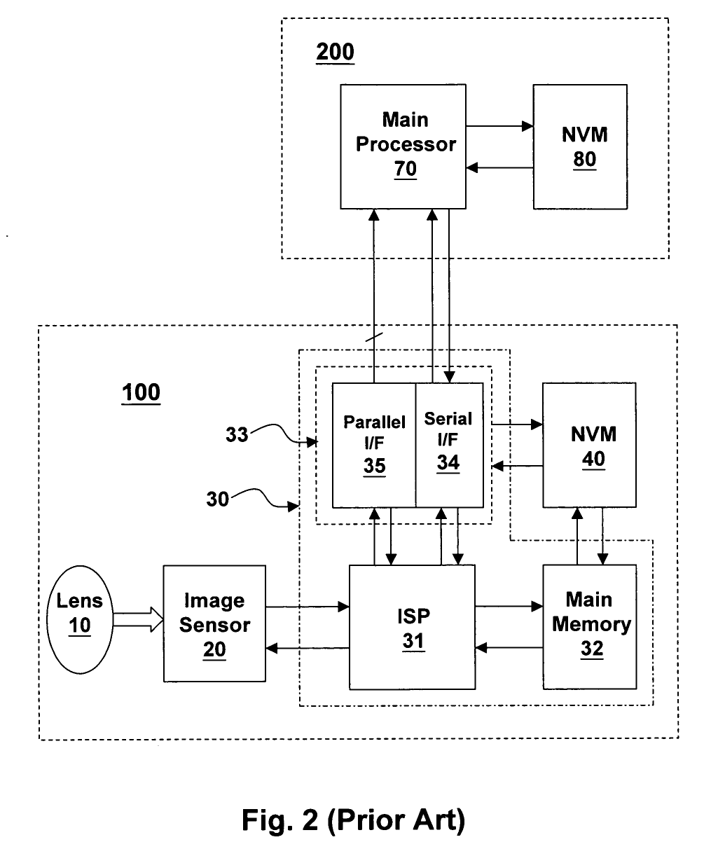

The main difference between the structure shown in FIG. 4 and that shown in FIGS. 1 and 2 is the omission of a non-volatile memory 40 for storing booting program and various parameters. The booting program for the ISP 31 and the parameters for the image processing module 100 are not stored in the non-volatile memory 40. Therefore, by omission of the non-volatile memory 40, the hardware cost of the image processing module 100 is reduced, and the assembly efficiency is improved. Furthermore, the size of the image processing module 100 is reduced and more suitable for use in a portable electronic device.

The main control side 200 comprises a main processor 70 and a non-volatile memory 80 in cooperation with the main processor 70. Different from the conventional structure, the booting program (and other programs, if required) for the ISP 31 and the parameters for the image processing module 100 are stored in the non-volatile memory 80. The parameters may include, but are not limited to, focus calibration data, auto white balance data, color temperature detection data, color reproduction related data such as raw color property data or color matrix data, lens compensation data such as lens shading compensation data or chroma non-uniformity compensation data, etc.

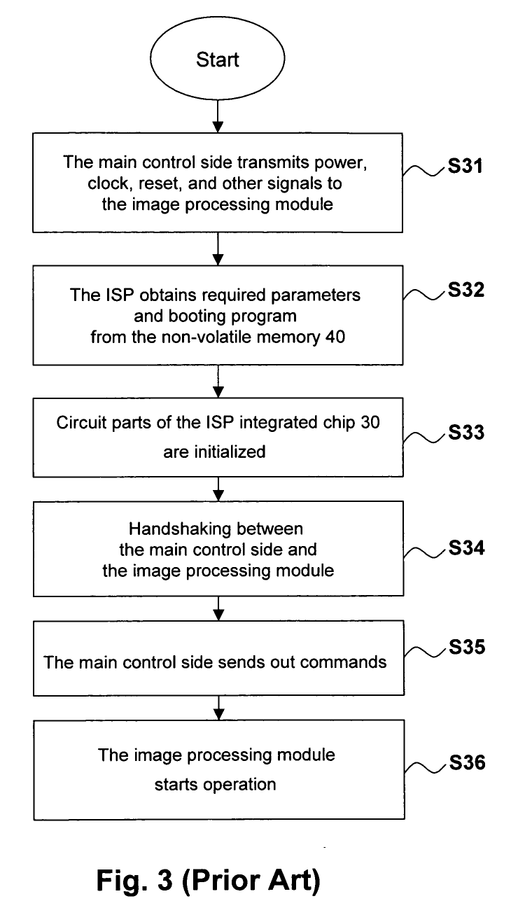

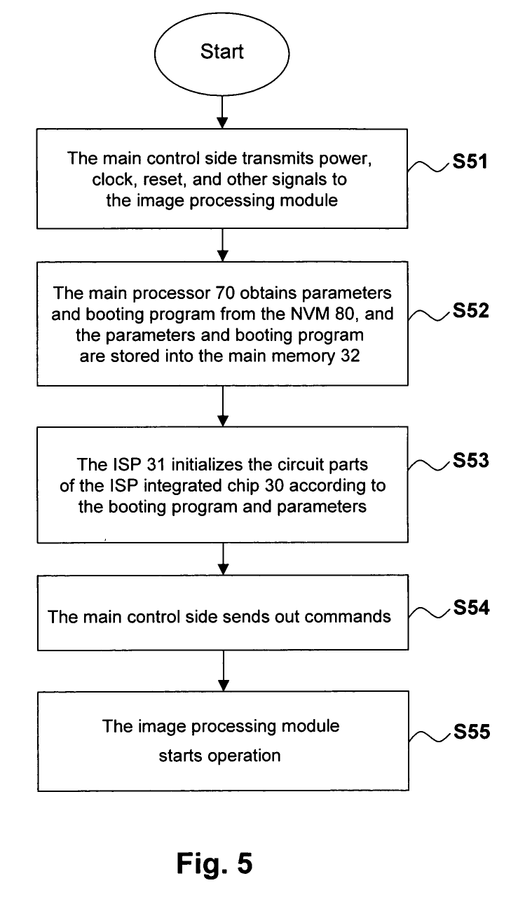

Under the structure described above, the booting process for the ISP 31 and the image processing module 100 is shown in FIG. 5. First, the main control side 200 transmits power, clock, reset and other signals to the image processing module 100 (step S51). Next, different from that shown in FIG. 3, the main processor 70 at the main control side 200 obtains parameters and a booting program required for initializing the ISP integrated chip 30 from the non-volatile memory 80, and sends them through a connection wire(s) to the interface 33 of the ISP integrated chip 30, to be stored into the main memory 32 (step S52). Thereafter, the main processor 70 notifies the ISP 31 that the transmission of required booting program and data has been completed, and the ISP 31 initializes the circuit parts of the ISP integrated chip 30 according to the booting program and data. When everything is ready, the ISP 31 may send back a confirmation signal to the main control side 200, or the main control side 200 may check whether the ISP 31 is ready by polling, until the ISP 31 is ready (step S53). Thereafter, the main control side 200 sends out commands, and the image processing module 100 starts operation (step S54-S55).

According to the present invention, in the step S52 described above, there are two preferable ways to transmit the booting program and parameters to the main memory 32. The first way is to send such booting program and parameters through the serial interface 34, that is, the register read/write interface. The second way is to do so by means of the parallel interface 35. The parallel interface 35 is originally designed for transmitting image data, but during the booting and initialization stage, it may be used for transmitting the booting program and parameters since there is not yet any image data to be transmitted. The parallel interface 35 may speed up the transmission of the booting program and parameters due to parallel transmission. However, in the conventional structure, the parallel interface 35 is only designed for transmitting image data from the image processing module 100 to the main control side 200, that is, the transmission is one-directional. According to the present invention, if the transmission of the booting program and parameters are achieved through the parallel interface 35, the connection between the main control side 200 and the parallel interface 35 should be modified so that bi-directional transmission may be achieved, as referring to FIG. 4 in comparison with FIG. 2.

The features, characteristics and effects of the present invention have been described with reference to its preferred embodiments, which are illustrative of the invention rather than limiting of the invention. Various other substitutions and modifications will occur to those skilled in the art, without departing from the spirit of the present invention. For example, the ISP 31, the main memory 32, and the interface 33 are not necessarily required to be integrated into one ISP integrated chip 30. As another example, the image sensor 20 may be integrated into the ISP integrated chip 30. As a further example, depending on the applications, the main control side and the image processing module are not necessarily required to be located separately. Therefore, all such substitutions and modifications are intended to be embraced within the scope of the invention as defined in the appended claims.

What is claimed is:

1. A structure for booting an image signal processor (ISP), comprising:
an image processing module; and
a main control side,
wherein said image processing module includes an ISP for processing image signals, and an interface for communication between said image processing module and said main control side;
wherein said main control side includes a main processor and a memory storing a booting program for said ISP; and
wherein said booting program is sent from said main control side to said image processing module for booting said ISP.

2. The structure for booting an ISP as claimed in claim 1, wherein said main control side transmits one or more of the following parameters to said image processing module in addition to said booting program: focus calibration data, auto white balance data, color temperature detection data, color reproduction related data, raw color property data, color matrix data, lens compensation data, lens shading compensation data, and chroma non-uniformity compensation data.

3. The structure for booting an ISP as claimed in claim 2, wherein said one or more parameters are stored in said memory of said main control side.

4. The structure for booting an ISP as claimed in claim 1, wherein said image processing module further comprises a focus lens and an image sensor for capturing an image through said focus lens.

5. The structure for booting an ISP as claimed in claim 1, wherein said interface includes a serial interface through which said booting program is transmitted.

6. The structure for booting an ISP as claimed in claim 1, wherein said interface includes a bi-directional parallel interface through which said booting program is transmitted.

7. The structure for booting an ISP as claimed in claim 1, wherein said image processing module includes a main memory for assisting the operation of said ISP, and wherein said ISP, said main memory and said interface are integrated into an IC chip.

8. A method for booting an image signal processor (ISP), comprises the steps of:
providing an image processing module which includes an ISP and an interface;
receiving a booting program from a circuit external to said image processing module; and
initializing said image processing module by said ISP according to said booting program.

9. The method as claimed in claim 8, further comprising the step of receiving one or more of the following parameters: focus calibration data, auto white balance data, color temperature detection data, color reproduction related data, raw color property data, color matrix data, lens compensation data, lens shading compensation data, and chroma non-uniformity compensation data.

10. The method as claimed in claim 9, wherein said booting program and said one or more parameters are stored in a memory external to said image processing module.

11. The method as claimed in claim 8, wherein said image processing module further comprises a focus lens and an image sensor for capturing an image through said focus lens.

12. The method as claimed in claim 8, wherein said interface includes a serial interface through which said booting program is transmitted.

13. The method as claimed in claim 8, wherein said interface includes a bi-directional parallel interface through which said booting program is transmitted.

14. An image processing module comprises:
a focus lens;
an image sensor for capturing an image through said focus lens;
an image signal processor (ISP) for processing an image signal generated by said image sensor;
a main memory assisting the operation of said ISP; and
an interface for communication with a circuit external to said image processing module,
characterized in that said main memory is a volatile memory which receives a booting program from said circuit external to said image processing module.

15. The image processing module as claimed in claim 14, wherein said main memory also receives one or more of the following parameters in addition to said booting program: focus calibration data, auto white balance data, color temperature detection data, color reproduction related data, raw color property data, color matrix data, lens compensation data, lens shading compensation data, and chroma non-uniformity compensation data.

16. The image processing module as claimed in claim 14, wherein said interface includes a serial interface through which said booting program is transmitted.

17. The image processing module as claimed in claim 14, wherein said interface includes a bi-directional parallel interface through which said booting program is transmitted.

18. The image processing module as claimed in claim 14, wherein said ISP, said main memory and said interface are integrated into an IC chip.

19. The image processing module as claimed in claim 18, wherein said ISP, said main memory, said interface and said image sensor are integrated into an IC chip.
